(19) United States
(12) Patent Application Publication
(10) Pub. No.: US 2005/0007310 A1
(43) Pub. Date: Jan. 13, 2005

(54) Apparatus and method for energy recovery

(76) Inventors: Tae Hyung Kim, Seoul (KR); Ji Seung Yoo, Yongin-si (KR)

Correspondence Address: FLESHNER & KIM, LLP, P.O. BOX 221200, CHANTILLY, VA, 20153, US

(21) Appl. No.: 10/858,542

(22) Filed: Jun. 2, 2004

(30) Foreign Application Priority Data
Jun. 2, 2003 (KR) 10-2003-0035336
Jul. 31, 2003 (KR) 10-2003-0049676

(51) Int. Cl. G09G 3/28

(52) U.S. Cl. 345/60

(57) ABSTRACT

The present invention relates to a plasma display panel, and more particularly, to an energy recovery apparatus for use in a driving device of a plasma display panel and method thereof. The energy recovery apparatus according to the present invention includes a capacitive load equivalently formed on a panel, a source capacitor that recovers a voltage charged to the capacitive load and is charged with the recovered voltage, a sustain voltage source for supplying a sustain voltage to the capacitive load, and an initial charging voltage source for supplying an initial charging voltage to the source capacitor.

This Nonprovisional application claims priority under 35 U.S.C. § 119(a) on Patent Application No. 10-2003-0035336 filed in Korea on Jun. 02, 2003, and Application No. 10-2003-0049676 filed in Korea on Jul. 21, 2003, the entire contents of which are hereby incorporated by reference.

### BACKGROUND OF THE INVENTION

1. Field of the Invention

The present invention relates to a plasma display panel, and more particularly, to an energy recovery apparatus for use in a driving device of a plasma display panel and method thereof.

2. Description of the Background Art

A variety of flat panel display devices wherein the weight and volume being disadvantages of a cathode ray tube are reduced have recently been developed. These flat panel display devices include a liquid crystal display (LCD), a field emission display (FED), a plasma display panel (PDP), an electro-luminescence (EL) display device and the like.

Of them, the PDP is of a display device using gas discharge and is advantageous in that it can be fabricated as a large-scale panel. A representative one of the PDP is a three-electrode AC surface discharge type PDP having 3 electrodes and driven by the AC voltage, as shown in FIG. 1.

Referring to FIG. 1, a discharge cell of a three-electrode AC surface discharge type PDP includes a scan electrode Y and a sustain electrode Z which are formed on the bottom surface of an upper substrate 10, and an address electrode X formed on a lower substrate 18.

Each of the scan electrode Y and the sustain electrode Z include transparent electrodes 12Y and 12Z, and metal bus electrodes 13Y and 13Z which have a line width smaller than that of the transparent electrodes 12Y and 12Z and are respectively disposed at one side edges of the transparent electrodes. The transparent electrodes 12Y and 12Z, which are generally made of ITO (indium tin oxide), are formed on the bottom surface of the upper substrate 10. The metal bus electrodes 13Y and 13Z, which are made of a metal such as chromium (Cr), are generally formed on the transparent electrodes 12Y and 12Z and serve to reduce a voltage drop caused by the transparent electrodes 12Y and 12Z having high resistance.

On the bottom surface of the upper substrate 10 in which the scan electrode Y and the sustain electrode Z are placed parallel to each other is laminated an upper dielectric layer 14 and a protective layer 16. The upper dielectric layer 14 is accumulated with a wall charge generated during plasma discharging. The protective layer 16 is adapted to prevent damages of the upper dielectric layer 14 due to sputtering caused during plasma discharging, and improve efficiency of secondary electron emission. As the protective layer 16, magnesium oxide (MgO) is generally used. A lower dielectric layer 22 and a barrier rib 24 are formed on the lower substrate 18 in which the address electrode X is formed. A phosphor layer 26 is applied to the surfaces of both the lower dielectric layer 22 and the barrier rib 24.

The address electrode X is formed in the direction in which the address electrode X intersects with the scan electrode Y and the sustain electrode Z. The barrier rib 24 is adapted to prevent an ultraviolet and a visible light generated by discharging from being leaked toward adjacent discharge cells. The phosphor layer 26 is excited with an ultraviolet generated during the plasma discharging to generate any one visible light of red, green and blue lights. An inert mixed gas for discharging such as He+Xe, Ne+Xe, He+Ne+Xe, etc. is injected into the discharge spaces defined between the upper substrate 10 and the barrier ribs 24 and between the lower substrate 18 and the barrier ribs 24.

This three-electrode AC surface discharge type PDP is divided into a plurality of sub-fields and is driven. In the period of each of the sub-fields, light is emitted by the number proportional to a weighted value of video data, thereby displaying gradations. A plurality of sub-fields SF1 to SF12 are sub-divided into a reset period, an address period, a sustain period and an erase period, and are driven.

Herein, the reset period is a period for forming an uniform wall charge on the discharge cell, the address period is a period for generating an selective address discharge according to a logical value of video data, and the sustain period is a period for maintaining discharge in the discharge cell from which the address discharge is generated. The erase period is a period for erasing a sustain discharge generated in the sustain period.

As such, an address discharge and a sustain discharge of the AC surface discharge type PDP driven require high voltage of more than several hundreds of volts. Thus, in order to minimize the driving power necessary for the address discharge and the sustain discharge, an energy recovery circuit is used. The energy recovery circuit serves to recover the voltage between the scan electrode Y and the sustain electrode Z, and use the recovered voltage as a driving voltage necessary for a subsequent discharge.

FIG. 2 is a circuit diagram showing a conventional energy recovery apparatus for recovering a sustain discharge voltage.

As shown in FIG. 2, the conventional energy recovery apparatuses 30 and 32 are disposed symmetrically to each other with a panel capacitor Cp intervened there between. In the above, the panel capacitor Cp equivalently represents capacitance generated between the scan electrode Y and the sustain electrode Z. The first energy recovery apparatus 30 serves to supply a sustain pulse to the scan electrode Y. The second energy recovery apparatus 32 functions to supply a sustain pulse to the sustain electrode Z while operating alternately along with the first energy recovery apparatus 30.

The construction of the conventional energy recovery apparatuses 30 and 32 will be described taking the first energy recovery apparatus 30 as the example. The first energy recovery apparatus 30 includes an inductor L connected between the panel capacitor Cp and a source capacitor Cs, first and third switches S1 and S3 connected in parallel between the source capacitor Cs and the inductor L, and second and fourth switches S2 and S4 connected in parallel between the panel capacitor Cp and the inductor L.

The second switch S2 is connected to a sustain voltage source Vs and the fourth switch S4 is connected to a ground voltage source GND. The source capacitor Cs recovers a voltage charged to the panel capacitor Cp, is charged with the recovered voltage, and then re-supplies the charged voltage to the panel capacitor Cp, during sustain discharge. The source capacitor Cs is charged with a voltage of Vs/2 corresponding to a half of the sustain voltage source Vs. The inductor L forms a resonant circuit together with the panel capacitor Cp. The first to fourth switches S1 to S4 serve to control the flow of the current.

Meanwhile, fifth and sixth diodes D5 and D6 each disposed between the first switch S1 and the inductor L and between the third switch S3 and the inductor L serves to prevent the current from flowing in the reverse direction. Furthermore, first to fourth diodes D1 to D4 being internal diodes of the first to fourth switches S1 to S4 functions to prevent the current from flowing in the reverse direction.

FIG. 3 is a timing diagram and a waveform showing on/off timing of switches and an output waveform of a panel capacitor in the first energy recovery apparatus.

The operation of the panel capacitor Cp will be described in detail assuming that before a T1 period, the panel capacitor Cp is charged with a voltage of 0 volt and the source capacitor Cs is charged with a voltage of Vs/2.

In the T1 period, the first switch S1 is turned on to form a current path from the source capacitor Cs to the panel capacitor Cp through the first switch S1 and the inductor L. If the current path is formed, the voltage of Vs/2 charged to the source capacitor Cs is supplied to the panel capacitor Cp. At this time, since the inductor L and the panel capacitor Cp form a serial resonant circuit, the panel capacitor Cp is charged with the Vs voltage that is twice as high as the voltage of the source capacitor Cs.

In a T2 period, the second switch S2 is turned on. If the second switch S2 is turned on, the voltage of the sustain voltage source Vs is supplied to the scan electrode Y. The voltage of the sustain voltage source Vs supplied to the scan electrode Y prevents the voltage of the panel capacitor Cp from falling below the sustain voltage source Vs, thereby generating sustain discharge. Meanwhile, since the voltage of the panel capacitor Cp rose up to Vs in the T1 period, the driving power supplied from the outside in order to generate the sustain discharge can be minimized.

In a T3 period, the first switch S1 is turned off. At this time, the scan electrode Y maintains the voltage of the sustain voltage source Vs during the T3 period. In a T4 period, the second switch S2 is turned off and the third switch S3 is turned on. If the third switch S3 is turned on, a current path from the panel capacitor Cp to the source capacitor Cs through the inductor L and the third switch S3 is formed. Thus the voltage charged to the panel capacitor Cp is recovered by the source capacitor Cs. At this time, the source capacitor Cs is charged with the voltage of Vs/2.

In a T5 period, the third switch S3 is turned off and the fourth switch S4 is turned on. If the fourth switch S4 is turned on, a current path is formed between the panel capacitor Cp and the ground voltage source GND, so that the voltage of the panel capacitor Cp falls to 0 volt. In a T6 period, the T5 state is maintained for a predetermined time. Actually, an AC driving pulse applied to the scan electrode Y and the sustain electrode Z is obtained as the T1 to T6 periods are periodically repeated.

Meanwhile, the second energy recovery apparatus 32 and the first energy recovery apparatus 30 operate in turn to supply the driving voltage to the panel capacitor Cp, as shown in FIG. 4. Accordingly, the panel capacitor Cp is supplied with the sustain pulse voltage Vs of an opposite polarity, as shown in FIG. 4. As such, as the sustain pulse voltage Vs of an opposite polarity is supplied to the panel capacitor Cp, the sustain discharge occurs in the discharge cell.

In these energy recovery apparatuses 30 and 32, the source capacitor Cs being a capacitor for energy storage is charged with a voltage corresponding to ½ of the sustain voltage Vs. For example, if a sustain voltage Vs of 180V is used, the source capacitor Cs is charged with a voltage of 90V. In this case, what the source capacitor Cs is charging with 90V means that the source capacitor Cs is charged in a balanced state after the energy recovery operation is performed. That is, when the energy recovery apparatuses 30 and 32 are initially driven, the energy recovery operation is performed several times and a charge voltage in the source capacitor Cs is gradually increased from 0V until the equilibrium state is attained.

However, as the source capacitor Cs is 0V when the energy recovery apparatuses 30 and 32 are initially driven, the withstanding voltage of the third switch S3 becomes approximately 180V being the sustain voltage Vs. Thus, in case of the third switch Q3, a switch of about 250V whose rated voltage is greater than the sustain voltage Vs has to be used considering a voltage margin. Accordingly, there is a disadvantage that the cost is increased when constructing the energy recovery circuit.

Furthermore, in such conventional energy recovery apparatuses 30 and 32, the voltage less than Vs/2 is recovered by the source capacitor Cs due to line impedance (or resistance) existing in the current path. As such, if the voltage less than Vs/2 is recovered by the source capacitor Cs, there is a problem that a high current has to be flown into the second switch S2.

In the concrete, during the T4 period, the voltage VCp recovered by the source capacitor Cs is set to a voltage value less than Vs/2 because of the effects such as line impedance, as shown in FIG. 5. Moreover, during the T1 period, the voltage Vcp charged to the source capacitor Cs is applied to the panel capacitor Cp through the inductor L. In the above, a 2Vcp voltage greater twice than the voltage charged to the source capacitor Cs is charged to the panel capacitor Cp due to resonance between the inductor L and the panel capacitor Cp. At this time, since the charged voltage Vcp of the panel capacitor Cp is less than Vs/2, the voltage charged to the panel capacitor Cp during the T1 period set less than Vs.

As such, if the voltage less than Vs is charged to the panel capacitor Cp during the T1 period, it is required that the current that charges the panel capacitor Cp up to the voltage of Vs as well as a discharge current be additionally supplied through the second switch S2 during the T2 period. That is, during the T2 period, lots of the current flows into the second switch S2. Accordingly, since high heat is generated in the second switch S2, there is a problem that the second switch S2 may be broken. Furthermore, there is also a problem that the size of a heat sink is increased in order to sufficiently radiate high heat occurring in the second switch S2. Meanwhile, conventionally, the second switch S2 having a withstanding voltage property is used to prevent the second switch S2 form being broken. It is, however, difficult to completely prevent the second switch S2 from being broken. Further, the manufacturing cost is increased since a switch of a high voltage-resistant property is used.

### SUMMARY OF THE INVENTION

Accordingly, an object of the present invention is to solve at least the problems and disadvantages of the background art.

An object of the present invention is to provide an energy recovery apparatus for use in a driving device of a plasma display panel that can prevent elements from being broken due to heat and reduce the manufacturing cost, and method thereof.

According to an embodiment of the present invention, there is provided an energy recovery apparatus, including: a panel capacitor equivalently formed on a discharge cell; a source capacitor that is charged with a voltage charged to the panel capacitor, for re-supplying the charged voltage to the panel capacitor; a sustain voltage source that is supplied to maintain the voltage charged to the panel capacitor when the panel capacitor is charged with the voltage of the source capacitor; an inductor disposed between one side of the source capacitor and the panel capacitor; and an initial charging voltage source for supplying the initial charging voltage to the source capacitor.

According to an embodiment of the present invention, there is provided an energy recovery method, including the steps of: supplying a voltage received from an initial charging voltage source to a source capacitor, thus charging the source capacitor with a first voltage value; supplying the voltage charged to the source capacitor to a capacitive load that is equivalently formed on a panel; supplying a sustain voltage to the capacitive load; and allowing the source capacitor to recover the voltage charged to the capacitive load and then to be charged with a second voltage value.

According to another embodiment of the present invention, there is also provided an energy recovery apparatus, including a panel capacitor equivalently formed on a discharge cell; a source capacitor that is charged with a voltage charged to the panel capacitor, for re-supplying the charged voltage to the panel capacitor; a sustain voltage source that is supplied to maintain the voltage charged to the panel capacitor when the panel capacitor is charged with the voltage of the source capacitor; an inductor disposed between one side of the source capacitor and the panel capacitor; and a voltage supply unit connected to the other side of the source capacitor.

According to another embodiment of the present invention, there is also provided an energy recovery method, comprising the steps of: charging a panel capacitor with a voltage charged to a source capacitor; supplying a sustain voltage to the panel capacitor; charging the source capacitor with the voltage charged to the panel capacitor; and supplying a reference voltage to the source capacitor.

### BRIEF DESCRIPTION OF THE DRAWINGS

The invention will be described in detail with reference to the following drawings in which like numerals refer to like elements.

FIG. 1 is a perspective view showing the construction of a conventional three-electrode AC surface discharge type plasma display panel.

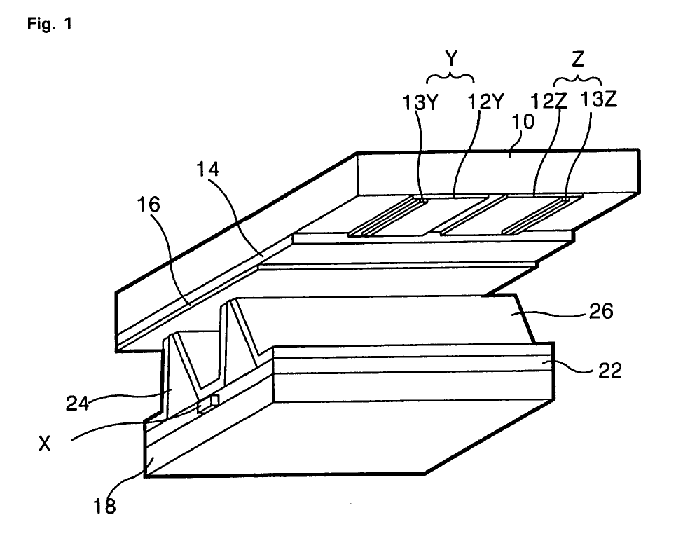

FIG. 2 is a circuit diagram showing a conventional energy recovery apparatus.

FIG. 3 is a timing diagram and a waveform showing on/off timing of switches and an output waveform of a panel capacitor shown in FIG. 2.

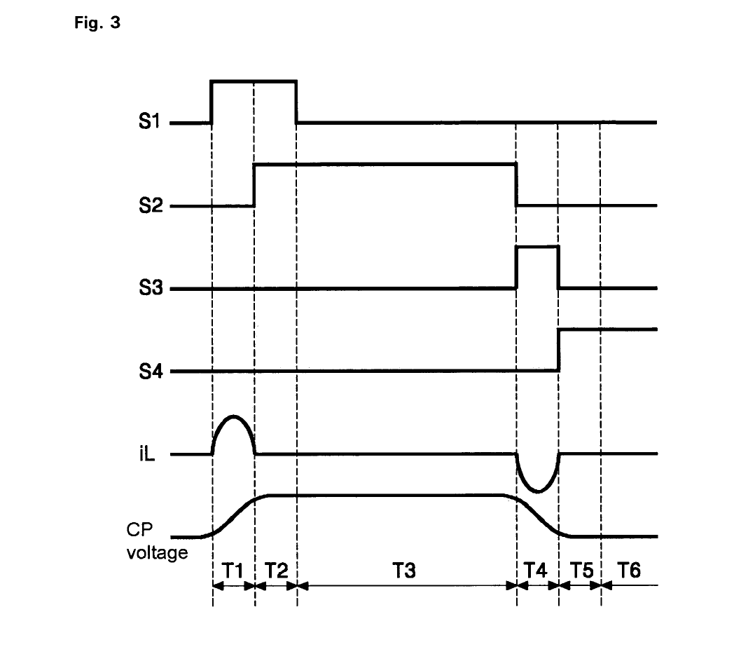

FIG. 4 shows a waveform showing a voltage applied to a panel capacitor by means of the energy recovery apparatus shown in FIG. 2.

FIG. 5 shows a voltage value charged to the panel capacitor shown in FIG. 2.

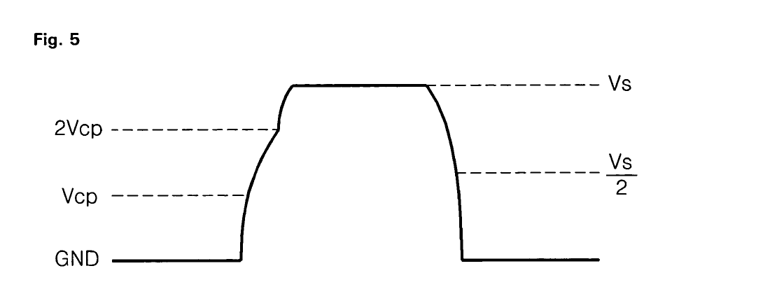

FIG. 6 is a circuit diagram showing an energy recovery apparatus according to an embodiment of the present invention.

FIG. 7 is a timing diagram and a waveform showing on/off timing of switches and an output waveform of a panel capacitor shown in FIG. 6.

FIG. 8 shows a voltage value charged to the panel capacitor by means of the energy recovery apparatus shown in FIG. 6.

FIG. 9 is a circuit diagram showing an energy recovery apparatus according to another embodiment of the present invention.

FIG. 10 is a circuit diagram showing an energy recovery apparatus according to further another embodiment of the present invention.

FIG. 11 is a circuit diagram showing an energy recovery apparatus according to further another embodiment of the present invention

FIG. 12 is a timing diagram and a waveform showing on/off timing of switches and an output waveform of a panel capacitor shown in FIG. 11.

FIG. 13 shows a voltage value charged to the panel capacitor shown in FIG. 11.

### DETAILED DESCRIPTION OF PREFERRED EMBODIMENTS

According to an embodiment of the present invention, there is provided an energy recovery apparatus, including: a panel capacitor equivalently formed on a discharge cell; a source capacitor that is charged with a voltage charged to the panel capacitor, for re-supplying the charged voltage to the panel capacitor; a sustain voltage source that is supplied to maintain the voltage charged to the panel capacitor when the panel capacitor is charged with the voltage of the source capacitor; an inductor disposed between one side of the source capacitor and the panel capacitor; and an initial charging voltage source for supplying the initial charging voltage to the source capacitor.

In the energy recovery apparatus, the voltage value of the initial charging voltage source is set differently from the voltage value of the sustain voltage source.

In the energy recovery apparatus, the voltage value of the initial charging voltage source is less than that of the sustain voltage source.

In the energy recovery apparatus, the voltage value of the initial charging voltage source is less than or equal to a half of the sustain voltage source.

The energy recovery apparatus further includes a diode disposed between the source capacitor and the initial charging voltage source, for supplying the voltage received from the initial charging voltage source to the source capacitor.

The energy recovery apparatus further includes a switching element disposed between the source capacitor and the initial charging voltage source, wherein the switching element is turned on only when the source capacitor is initially charged.

The energy recovery apparatus further includes a diode disposed between the source capacitor and the switching element, for supplying the voltage received from the initial charging voltage source to the source capacitor.

According to an embodiment of the present invention, there is provided an energy recovery method, including the steps of: supplying a voltage received from an initial charging voltage source to a source capacitor, thus charging the source capacitor with a first voltage value; supplying the voltage charged to the source capacitor to a capacitive load that is equivalently formed on a panel; supplying a sustain voltage to the capacitive load; and allowing the source capacitor to recover the voltage charged to the capacitive load and then to be charged with a second voltage value.

In the energy recovery method, the first voltage value is different from the second voltage value.

In the energy recovery method, the first voltage value is less than the second voltage value.

In the energy recovery method, the voltage from the initial charging voltage source is supplied only in the initial period except for the period where the source capacitor is charged with a voltage.

According to another embodiment of the present invention, there is also provided an energy recovery apparatus, including a panel capacitor equivalently formed on a discharge cell; a source capacitor that is charged with a voltage charged to the panel capacitor, for re-supplying the charged voltage to the panel capacitor; a sustain voltage source that is supplied to maintain the voltage charged to the panel capacitor when the panel capacitor is charged with the voltage of the source capacitor; an inductor disposed between one side of the source capacitor and the panel capacitor; and a voltage supply unit connected to the other side of the source capacitor.

The voltage supply unit includes a first switch connected between the other side of the source capacitor and a reference voltage source, and a second switch connected between the other side of the source capacitor and a ground voltage source.

The voltage value of the reference voltage source is set to have a voltage corresponding to a half of the sustain voltage source to which the voltage value charged to the source capacitor is added.

The voltage value of the reference voltage source is set greater than a half of the sustain voltage source to which the voltage value charged to the source capacitor is added.

The first and second switches operate in turn.

The first switch is turned on only when the voltage of the reference voltage source is supplied to the source capacitor, and the second switch is turned on anytime except for only when the voltage of the reference voltage source is supplied to the source capacitor.

According to another embodiment of the present invention, there is also provided an energy recovery method, comprising the steps of: charging a panel capacitor with a voltage charged to a source capacitor; supplying a sustain voltage to the panel capacitor; charging the source capacitor with the voltage charged to the panel capacitor; and supplying a reference voltage to the source capacitor.

The value of the reference voltage is set approximately ½ of the sustain voltage to which the voltage value charged to the source capacitor is added.

The value of the reference voltage is set greater than ½ of the sustain voltage to which the voltage value charged to the source capacitor is added.

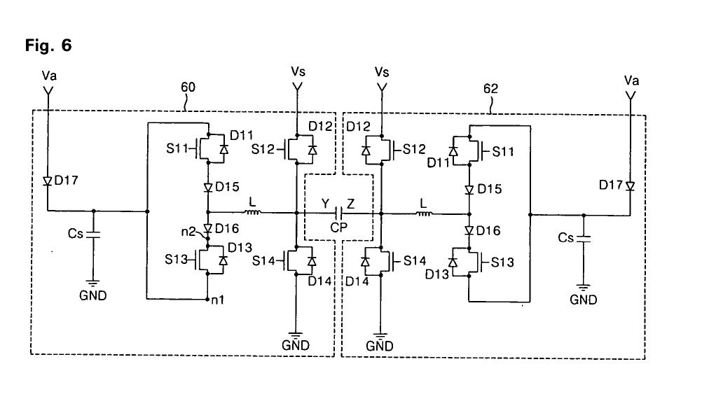

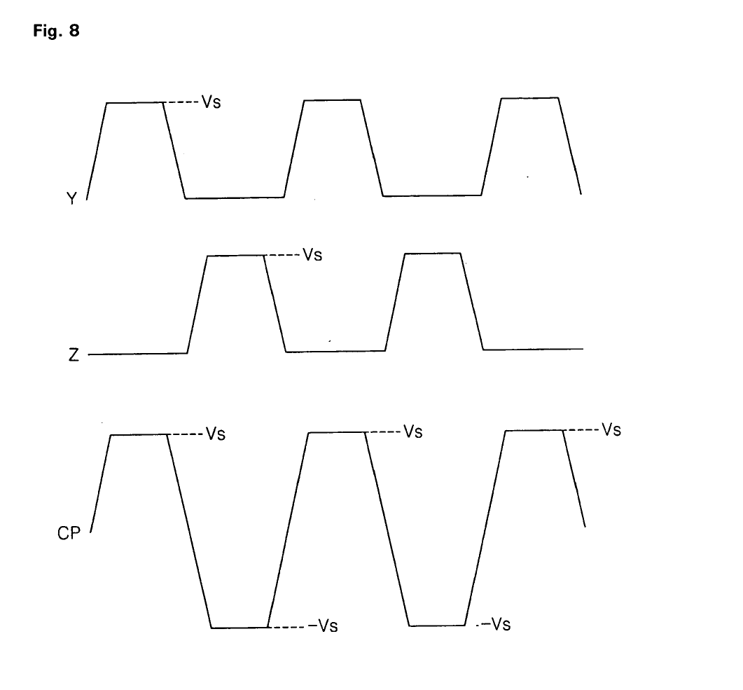

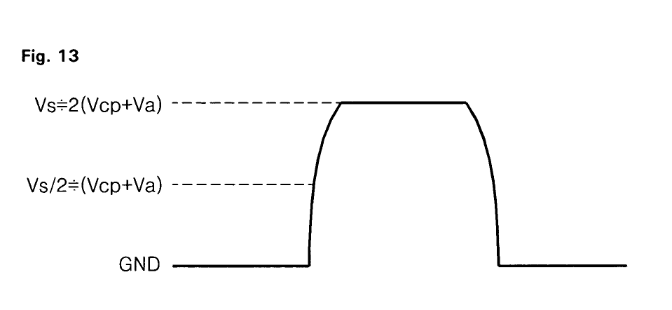

Preferred embodiments of the present invention will be described in a more detailed manner with reference to the accompanying FIG. 6 to FIG. 13.

FIG. 6 is a circuit diagram showing an energy recovery apparatus according to an embodiment of the present invention.

As shown in FIG. 6, energy recovery apparatuses 60 and 62 according to an embodiment of the present invention are disposed symmetrically to each other with a panel capacitor Cp intervened therebetween. The panel capacitor Cp equivalently represents capacitance generated between a scan electrode Y and a sustain electrode Z. The first energy recovery apparatus 60 serves to supply a sustain pulse to the scan electrode Y. The second energy recovery apparatus 62 functions to supply a sustain pulse to the sustain electrode Z while operating alternately with the first energy recovery apparatus 30.

The constructions of the conventional energy recovery apparatuses 30 and 32 according to an embodiment of the present invention will be described taking the first energy recovery apparatus 60 as the example. The first energy recovery apparatus 60 includes a source capacitor Cs disposed between an initial charging voltage source Va and a ground voltage source GND, an inductor L connected between the source capacitor Cs and a panel capacitor Cp, first and third switches S11 and S13 each connected in parallel between the source capacitor Cs and the inductor L, and second and fourth switches S12 and S14 connected in parallel between the panel capacitor Cp and the inductor L.

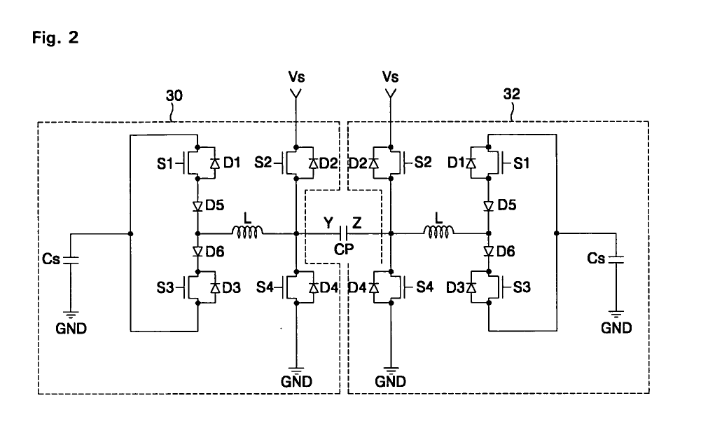

This energy recovery apparatus according to an embodiment of the present invention is the same as the conventional energy recovery apparatus shown in FIG. 2, except that it further includes the initial charging voltage source Va for charging the source capacitor Cs with the initial voltage, and a seventh diode D17 disposed between the initial charging voltage source Va and the source capacitor Cs for supplying the voltage value received from the initial charging voltage source Va to the source capacitor Cs.

The panel capacitor Cp equivalently represents capacitance generated between the scan electrode Y and the sustain electrode Z. The second switch S12 is connected to the sustain voltage source Vs and the fourth switch S14 is connected to the ground voltage source GND.

If this energy recovery apparatus is initially driven, the source capacitor Cs is charged with the voltage value of the initial charging voltage source Va. Thus, the initial charging voltage value Va is supplied to a first node n1 between the source capacitor Cs and the third switch S13. A sustain voltage value Vs is supplied to a second node n2 between the second switch S12 connected to the sustain voltage source Vs and the third switch S13. Therefore, the third switch S13 can only withstand a voltage as high as a voltage in which the initial charging voltage value Va is subtracted from the sustain voltage value Vs. That is, in the conventional energy recovery apparatus as shown in FIG. 2, it is required that a voltage that the third switch S3 has to withstand, i.e., an withstanding voltage be greater than the sustain voltage Vs considering the driving margin. Thus the cost is increased when the energy recovery circuit is constructed. On the contrary, in the energy recovery apparatus according to an embodiment of the present invention, a voltage that the third switch S13 has to withstand, i.e., an withstanding voltage can be less than the sustain voltage Vs considering the driving margin. It is thus possible to save the cost when constructing the energy recovery circuit. In this case, the initial charging voltage value Va is set to a voltage value less than a half of the sustain voltage Vs.

For instance, assuming that the value of the sustain voltage Vs is set to about 180V and the value of the initial charging voltage Va is set to about 65V, when the energy recovery apparatus is initially driven, the source capacitor Cs is charged with the voltage value 65V being a voltage value of the initial charging voltage source Va through the seventh diode D17. Accordingly, to the first node n1 is applied the voltage of 65V. Further, to the second node n2 is applied the voltage of 180V being the sustain voltage Vs. Therefore, the third switch S13 can withstand a voltage of about 115V in which 65V is subtracted from 180V. Accordingly, the withstanding voltage of the third switch S13 is about 150V considering the driving margin. It can be seen that this result is significantly low compared to 250V being the withstanding voltage of the conventional third switch S3. Thus, since a low withstanding voltage is used in the third switch S13, the cost can be saved when constructing the energy recovery circuit.

Meanwhile, after the initial operation, the source capacitor Cs recovers the voltage charged to the panel capacitor Cp during a sustain discharge, is charged with the recovered voltage, and then re-supplies the charged voltage to the panel capacitor Cp. At this time, the source capacitor Cs is charged with a voltage of Vs/2 corresponding to a half of the sustain voltage source Vs.

The inductor L forms a resonant circuit together with the panel capacitor Cp. The first to fourth switches S1 to S4 serve to control the flow of the current.

Meanwhile, fifth and sixth diodes D5 and D6 each disposed between the first switch S1 and the inductor L and between the second switch S1 and the inductor L, and a seventh diode D7 disposed between the initial charging voltage source Va and the source capacitor Cs serve to prevent the current from flowing in the reverse direction. Further, the first to fourth diodes D1 to D4 being internal diodes of the first to fourth switches S1 to S4 serve to prevent the current from flowing in the reverse direction.

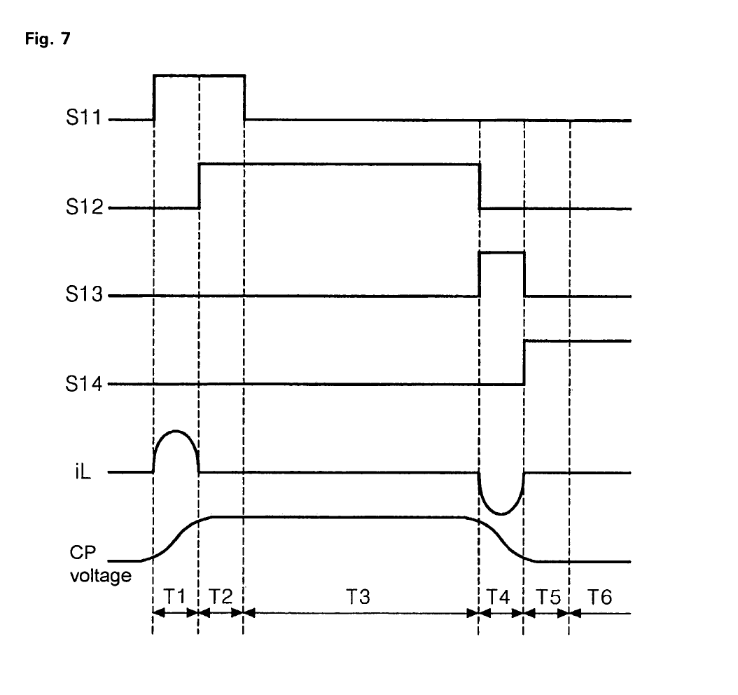

FIG. 7 is a timing diagram and a waveform showing on/off timing of switches and an output waveform of a panel capacitor shown in FIG. 6.

First, when the first energy recovery apparatus 60 is initially operated, a current path from the initial charging voltage source Va to the source capacitor Cs through the seventh diode D17 is formed. If the current path is formed, a voltage value of the initial charging voltage source Va is charged to the source capacitor Cs through the seventh diode D17. At this time, the initial charging voltage value Va is set to a voltage less than a half of the sustain voltage Vs.

In a T1 period, the first switch S1 is turned on to form a current path from the source capacitor Cs to the panel capacitor Cp through the first switch S1 and the inductor L. If the current path is formed, the initial charging voltage Va that has been charged to the source capacitor Cs is supplied to the panel capacitor Cp. Thereafter, the source capacitor Cs recovers the voltage that has been charged to the panel capacitor Cp in the sustain discharge and is thus charged with a Vs/2 voltage. The source capacitor Cs re-supplies the charged Vs/2 voltage to the panel capacitor Cp. At this time, since the inductor L and the panel capacitor Cp form a serial resonant circuit, the panel capacitor Cp is charged with a Vs voltage that is greater twice than the voltage of the source capacitor Cs.

In a T2 period, the second switch S2 is turned on. If the second switch S2 is turned on, the voltage of the sustain voltage source Vs is supplied to the scan electrode Y. The voltage of the sustain voltage source Vs supplied to the scan electrode Y prevents the voltage of the panel capacitor Cp from falling below the sustain voltage source Vs, so that a sustain discharge occurs. Meanwhile, since the voltage of the panel capacitor Cp rose up to Vs in the T1 period, the driving power supplied from the outside in order to generate the sustain discharge can be minimized.

In a T3 period, the first switch S1 is turned off. At this time, the scan electrode Y maintains the voltage of the sustain voltage source Vs during the T3 period. In a T4 period, the second switch S2 is turned off and the third switch S3 is turned on. If the third switch S3 is turned on, a current path from the panel capacitor Cp to the source capacitor Cs through the inductor L and the third switch S3 is formed. Thus the voltage charged to the panel capacitor Cp is recovered by the source capacitor Cs. In this case, the source capacitor Cs is charged with the voltage of Vs/2.

In a T5 period, the third switch S3 is turned off and the fourth switch S4 is turned on. If the fourth switch S4 is turned on, a current path is formed between the panel capacitor Cp and the ground voltage source GND, so that the voltage of the panel capacitor Cp falls down to 0 volt. In a T6 period, the T5 state is maintained for a predetermined time. In reality, an AC driving pulse applied to the scan electrode Y and the sustain electrode Z is obtained as the T1 to T6 periods are periodically repeated.

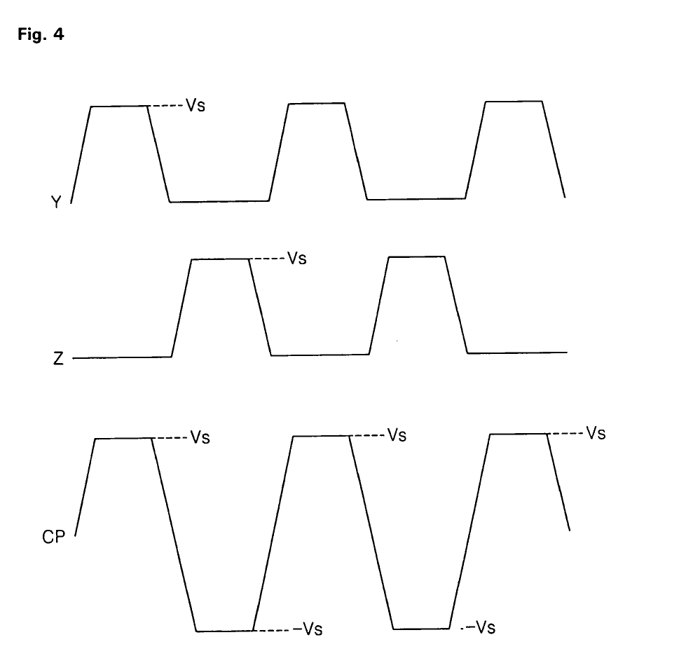

Meanwhile, the second energy recovery apparatus 32 and the first energy recovery apparatus 30 operate in turn to supply the driving voltage to the panel capacitor Cp, as shown in FIG. 4. Accordingly, the panel capacitor Cp is supplied with the sustain pulse voltage Vs of an opposite polarity, as shown in FIG. 4. Since the sustain pulse voltage Vs of the opposite polarity is supplied to the panel capacitor Cp, a sustain discharge occurs in the discharge cell.

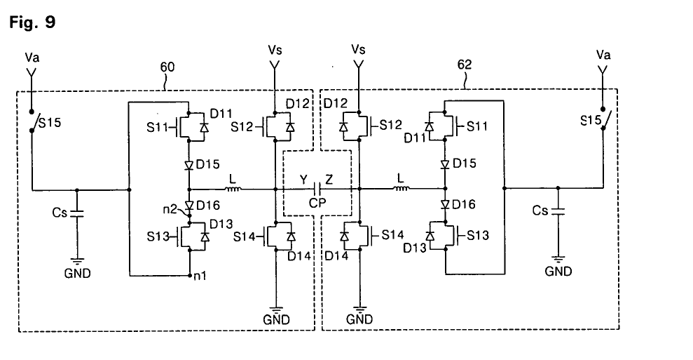

FIG. 9 is a circuit diagram showing an energy recovery apparatus according to another embodiment of the present invention.

In FIG. 9, the same components as those in FIG. 6 are designated with the same reference numerals. Thus detailed description on them will be omitted.

The energy recovery apparatus includes a source capacitor Cs disposed between an initial charging voltage source Va and a ground voltage source GND, a fifth switch S15 disposed between the initial charging voltage source Va and the source capacitor Cs, an inductor L connected between the source capacitor Cs and a panel capacitor Cp, first and third switches S11 and S13 each connected in parallel between the source capacitor Cs and the inductor L, and second and fourth switches S12 and S14 connected in parallel between the panel capacitor Cp and the inductor L.

This energy recovery apparatus according to another embodiment of the present invention is the same as the conventional energy recovery apparatus shown in FIG. 2 except that it further includes the initial charging voltage source Va for charging the source capacitor Cs with the initial voltage, and the fifth switch S15 disposed between the source capacitor Cs and the initial charging voltage source Va, wherein the fifth switch S15 is turned on only when the source capacitor Cs is initially charged.

Meanwhile, in the energy recovery apparatus according to another embodiment of the present invention, when the energy recovery apparatus is initially driven, the fifth switch S15 is turned on and the source capacitor Cs is thus charged with the initial charging voltage value Va. The charged initial charging voltage value Va lowers the withstanding voltage of the third switch S3. Thus, the cost is reduced when the energy recovery circuit is constructed, as in the aforementioned embodiment of the present invention. Thereafter, the fifth switch S15 is turned off so that there are no effects by the initial charging voltage value Va. Further, the fifth switch S15 serves to prevent the current from flowing in the reverse direction, like the seventh diode D7 according to the aforementioned embodiment of the present invention. Accordingly, the energy recovery apparatus does not require the seventh diode D7.

Meanwhile, after the initial operation, the source capacitor Cs recovers the voltage charged to the panel capacitor Cp in the sustain discharge, is charged with the recovered voltage, and then re-supplies the charged voltage to the panel capacitor Cp. At this time, the source capacitor Cs is charged with a voltage of Vs/2 corresponding to a half of the sustain voltage source Vs.

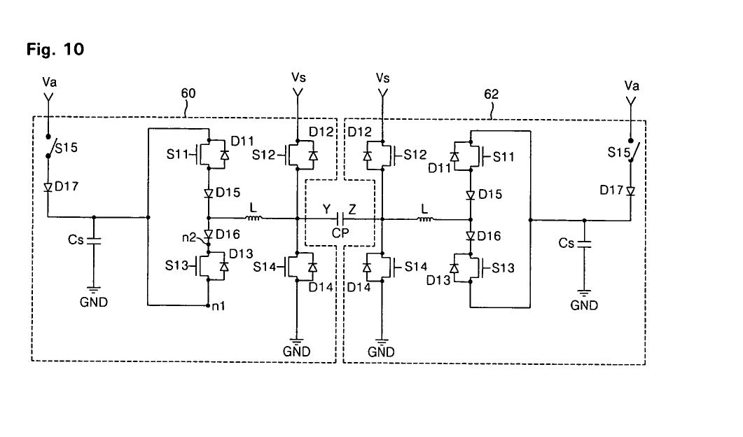

Meanwhile, in the energy recovery apparatus according to another embodiment of the present invention, as shown in FIG. 10, a seventh diode D17 can be disposed between the fifth switch S15 and the source capacitor Cs. The seventh diode D17 serves not only to supply a voltage received from the initial charging voltage source Va to the source capacitor Cs but also to prevent the current from flowing in the reverse direction.

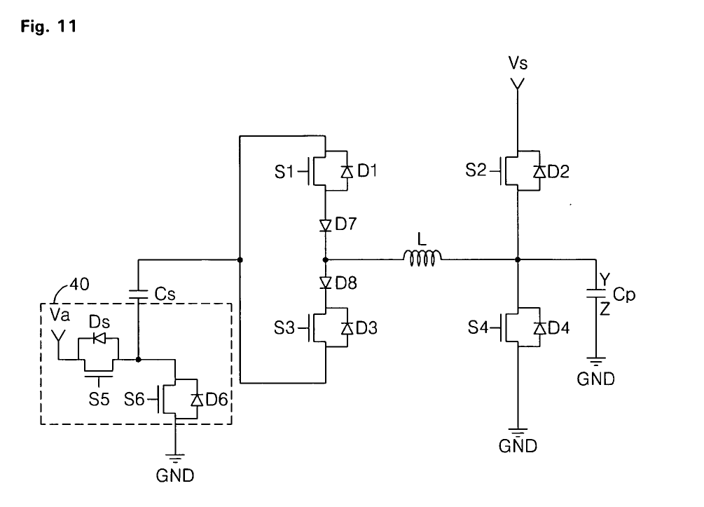

FIG. 11 is a circuit diagram showing an energy recovery apparatus according to further another embodiment of the present invention. In FIG. 11, it is shown that only the energy recovery apparatus is disposed on the side of the scan electrode Y of the panel capacitor Cp. It is, however noted that the energy recovery apparatus can be disposed on the side of the sustain electrode Z of the panel capacitor Cp. The panel capacitor Cp equivalently represents capacitance generated between the scan electrode Y and the sustain electrode Z.

Reference to FIG. 11, the energy recovery apparatus according to another embodiment of the present invention includes an inductor L connected between a panel capacitor Cp and a source capacitor Cs, first and third switches S1 and S3 connected in parallel between the source capacitor Cs and the inductor L, second and fourth switches S2 and S4 connected in parallel between the panel capacitor Cp and the inductor L, and a voltage supply unit 40 connected to the source capacitor Cs.

The second switch S2 is connected to the sustain voltage source Vs and the fourth switch S4 is connected to the ground voltage source GND. The source capacitor Cs recovers the voltage charged to the panel capacitor Cp in a sustain discharge, is charged with the recovered voltage, and then re-supplies the charged voltage to the panel capacitor Cp. The inductor L forms a resonant circuit together with the panel capacitor Cp. The first to fourth switches S1 to S4 control the flow of the current. Seventh and eighth diodes D7 and D9 prevent the current from flowing in the reverse direction.

The voltage supply unit 40 includes a sixth switch S6 connected between the source capacitor Cs and a ground voltage source GND, and a fifth switch S5 connected between the source capacitor Cs and a reference voltage source Va.

If the fifth switch S5 is turned on, the reference voltage source Va is supplied to the source capacitor Cs. That is, if the fifth switch S5 is turned on, the voltage of the reference voltage source Va is added to the voltage charged to the source capacitor Cs. In the concrete, if the fifth switch S5 is turned on, one side of the source capacitor Cs, for example the negative polarity side is supplied with the reference voltage source Va. In the above, if the negative polarity side of the source capacitor Cs is set to the voltage value of the reference voltage source Va, the other side of the source capacitor Cs (for example, the positive polarity side) has a voltage value in which the voltage charged thereto and the reference voltage source Va are added. Meanwhile, the voltage value of the reference voltage source Va is set to about Vs/2 to which the voltage value charged to the source capacitor Cs is added. In reality, considering a line impedance value acting when the voltage charged to the source capacitor Cs is discharged, the voltage of the reference voltage source Va can be set to a value a little greater than Vs/2 to which the voltage value charged to the source capacitor Cs is added.

If the sixth switch S6 is turned on, the ground voltage source GND is applied to the source capacitor Cs. These fifth and sixth switches S5 and S6 are turned on in turn.

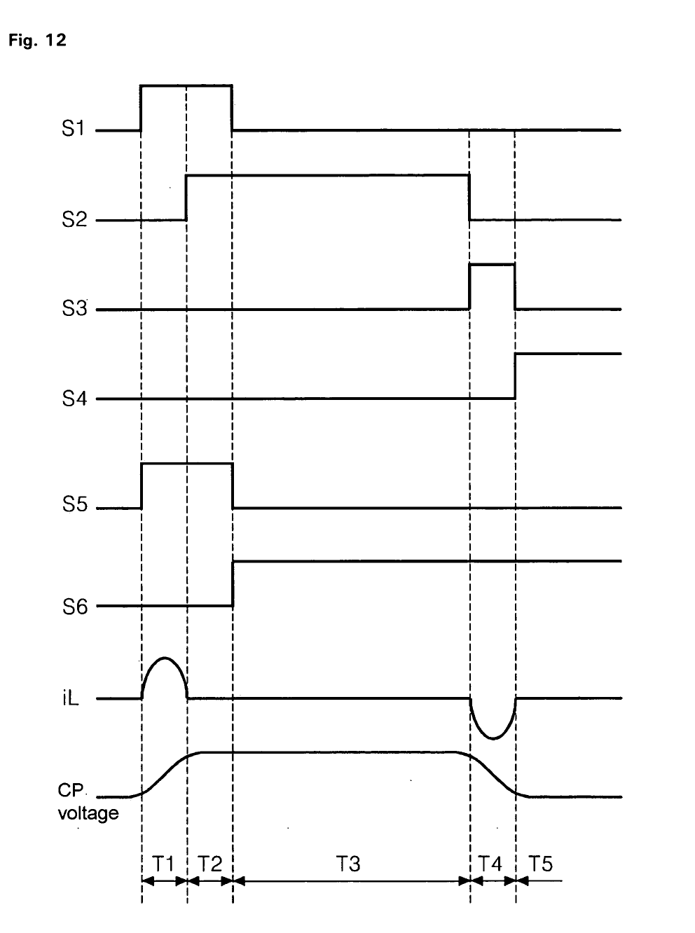

FIG. 12 is a timing diagram and a waveform showing on/off timing of switches and an output waveform of a panel capacitor shown in FIG. 11.

The operation of the panel capacitor will be described in detail assuming that before a T1 period, the panel capacitor Cp is charged with a voltage of 0 volt, and the source capacitor Cs recovers the voltage charged to the panel capacitor Cp and is then charged with the recovered voltage.

In the T1 period, the first and fifth switches S1 and S5 are turned on. If the fifth switches S1 and S5 are turned on, one side of the source capacitor Cs is supplied with the reference voltage Va. The other side of the source capacitor Cs has a voltage of Vs/2 (or a little greater than Vs/2) wherein the voltage charged before the T1 period and the reference voltage Va are added. If the first switch S1 is turned on, a current path from the other side of the source capacitor Cs to the panel capacitor Cp through the first switch S1 and the inductor L is formed. If the current path is formed, a voltage (that is, a voltage of approximately Vs/2) of the source capacitor Cs is applied to the panel capacitor Cp. In this case, since the inductor L and the panel capacitor Cp forms a serial resonant circuit, the panel capacitor Cp is charged with the Vs voltage.

In a T2 period, the second switch S2 is turned on. If the second switch S2 is turned on, the voltage of the sustain voltage source Vs is supplied to the scan electrode Y. The voltage of the sustain voltage source Vs supplied to the scan electrode Y prevents the voltage of the panel capacitor Cp from falling below the sustain voltage source Vs, so that a sustain discharge occurs. Meanwhile, since the voltage of the panel capacitor Cp rose up to Vs in the T1 period, the driving power supplied from the outside in order to generate the sustain discharge can be minimized.

In a T3 period, the first switch S1 and the fifth switch S5 are turned off and at the same time the sixth switch S6 is turned on. If the sixth switch S6 is turned on, one side of the source capacitor Cs is supplied with the ground voltage source GND. Meanwhile, during the T3 period, the scan electrode Y maintains the voltage of the sustain voltage source Vs.

In a T4 period, the second switch S2 is turned off and simultaneously the third switch S3 is turned on. If the third switch S3 is turned on, a current path from the panel capacitor Cp to the ground voltage source GND through the inductor L, the third switch S3 and the source capacitor Cs is formed. Thus the voltage charged to the panel capacitor Cp is recovered by the source capacitor Cs. At this time, the source capacitor Cs is charged with a voltage less than Vs/2 due to line impedance.

In a T5 period, the third switch S3 is turned off and the fourth switch S4 is turned on. If the fourth switch S4 is turned on, a current path is formed between the panel capacitor Cp and the ground voltage source GND, so that the voltage of the panel capacitor Cp falls to 0 volt. In reality, the energy recovery apparatus of the present invention supplies the driving voltage to the panel capacitor Cp while repeating the periods T1 to T5.

In the energy recovery apparatus according to another embodiment of the present invention, the voltage charged to the source capacitor Cs, which is less than Vs/2 due to line impedance (or resistance), is compensated by means of the voltage value of the reference voltage source Va (i.e., the source capacitor Cs has the voltage of approximately Vs/2 by supplying the voltage of Va). It is thus possible to minimize the current flowing into the second switch S2.

In the concrete, if the fifth switch S5 is turned on, the source capacitor Cs has a voltage of approximately Vs/2, as shown in FIG. 7. Therefore, the voltage of the panel capacitor Cp can rise up to a voltage of approximately Vs during the T1 period by means of the voltage of approximately Vs/2 charged to the source capacitor Cs. As such, if the panel capacitor Cp is charged with the voltage of approximately Vs during the T1 period, only the discharge current is supplied via the second switch S2 during the T2 period (i.e., the current that charges the panel capacitor Cp up to the voltage of Vs is not additionally supplied). Accordingly, in the energy recovery apparatus of the present invention, it is possible to prevent high heat from occurring in the second switch S2 and to prevent damage of the second switch S2. Furthermore, since high heat is not generated in the second switch S2, the size of a heat sink needs not to be additionally increased. Also, since the withstanding voltage of the second switch S2 is less than the prior art, the manufacturing cost can be reduced.

As described above, according to an energy recovery apparatus and method thereof according to an embodiment of the present invention, an initial charging voltage source connected to a source capacitor, and an initial charging voltage is then charged to the source capacitor when the energy recovery apparatus is initially driven. Thus the rated voltage of a switching element is lowered. It is therefore possible to reduce the cost when the energy recovery circuit is constructed.

Furthermore, according to an energy recovery apparatus and method thereof according to another embodiment of the present invention, a voltage charged to a source capacitor is kept approximately Vs/2 by supplying a voltage of a reference voltage source to a source capacitor. Therefore, a sustain voltage of approximately Vs is charged when the panel capacitor is charged with the voltage of the source capacitor. As such, if the panel capacitor is charged with the sustain voltage Vs, only a discharge current flows into a switch connected to an external sustain voltage source Vs. It is thus possible to prevent damage of the switch. Incidentally, since only the discharge current flows into the switch, high heat is not generated. Accordingly, the size of a heat sink needs not to be increased. Also, since only the discharge current flows into the switch, it is possible to lower the withstanding voltage of the switch and thus save the manufacturing cost.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An energy recovery apparatus, comprising:
a panel capacitor equivalently formed on a discharge cell;
a source capacitor that is charged with a voltage charged to the panel capacitor, for re-supplying the charged voltage to the panel capacitor;
a sustain voltage source that is supplied to maintain the voltage charged to the panel capacitor when the panel capacitor is charged with the voltage of the source capacitor;
an inductor disposed between one side of the source capacitor and the panel capacitor; and
an initial charging voltage source for supplying the initial charging voltage to the source capacitor.

2. The energy recovery apparatus of claim 1, wherein the voltage value of the initial charging voltage source is set differently from the voltage value of the sustain voltage source.

3. The energy recovery apparatus of claim 2, wherein the voltage value of the initial charging voltage source is less than that of the sustain voltage source.

4. The energy recovery apparatus of claim 3, wherein the voltage value of the initial charging voltage source is less than or equal to a half of the sustain voltage source.

5. The energy recovery apparatus of claim 1, further comprising a diode disposed between the source capacitor and the initial charging voltage source, for supplying the voltage received from the initial charging voltage source to the source capacitor.

6. The energy recovery apparatus of claim 1, further comprising a switching element disposed between the source capacitor and the initial charging voltage source, wherein the switching element is turned on only when the source capacitor is initially charged.

7. The energy recovery apparatus of claim 6, further comprising a diode disposed between the source capacitor and the switching element, for supplying the voltage received from the initial charging voltage source to the source capacitor.

8. An energy recovery method, comprising the steps of:
supplying a voltage received from an initial charging voltage source to a source capacitor, thus charging the source capacitor with a first voltage value;
supplying the voltage charged to the source capacitor to a capacitive load that is equivalently formed on a panel;
supplying a sustain voltage to the capacitive load; and
allowing the source capacitor to recover the voltage charged to the capacitive load and then to be charged with a second voltage value.

9. The energy recovery method of claim 8, wherein the first voltage value is different from the second voltage value.

10. The energy recovery method of claim 9, wherein the first voltage value is less than the second voltage value.

11. The energy recovery method of claim 8, wherein the voltage from the initial charging voltage source is supplied only in the initial period except for the period where the source capacitor is charged with a voltage.

12. An energy recovery apparatus, comprising:
a panel capacitor equivalently formed on a discharge cell;
a source capacitor that is charged with a voltage charged to the panel capacitor, for re-supplying the charged voltage to the panel capacitor;
a sustain voltage source that is supplied to maintain the voltage charged to the panel capacitor when the panel capacitor is charged with the voltage of the source capacitor;
an inductor disposed between one side of the source capacitor and the panel capacitor; and
a voltage supply unit connected to the other side of the source capacitor.

13. The energy recovery apparatus of claim 12, wherein the voltage supply unit comprises: a first switch connected between the other side of the source capacitor and a reference voltage source; and a second switch connected between the other side of the source capacitor and a ground voltage source.

14. The energy recovery apparatus of claim 13, wherein the voltage value of the reference voltage source is set to have a voltage corresponding to a half of the sustain voltage source to which the voltage value charged to the source capacitor is added.

15. The energy recovery apparatus of claim 13, wherein the voltage value of the reference voltage source is set greater than a half of the sustain voltage source to which the voltage value charged to the source capacitor is added.

16. The energy recovery apparatus of claim 13, wherein the first and second switches operate in turn.

17. The energy recovery apparatus of claim 16, wherein the first switch is turned on only when the voltage of the reference voltage source is supplied to the source capacitor, and the second switch is turned on anytime except for only when the voltage of the reference voltage source is supplied to the source capacitor.

18. An energy recovery method, comprising the steps of:
charging a panel capacitor with a voltage charged to a source capacitor;
supplying a sustain voltage to the panel capacitor;
charging the source capacitor with the voltage charged to the panel capacitor; and
supplying a reference voltage to the source capacitor.

19. The energy recovery method of claim 18, wherein the value of the reference voltage is set approximately ½ of the sustain voltage to which the voltage value charged to the source capacitor is added.

20. The energy recovery method of claim 18, wherein the value of the reference voltage is set greater than ½ of the sustain voltage to which the voltage value charged to the source capacitor is added.
